(19) United States
(12) Patent Application Publication
(10) Pub. No.: US 2023/0297830 A1
(43) Pub. Date: Sep. 21, 2023

(54) AUTOMATED MACHINE LEARNING METHOD AND APPARATUS THEREFOR

(71) Applicant: NEUROCLE INC., Seoul (KR)

(72) Inventors: Jae Hwan LEE, Seongnam-si, Gyeonggi-do (KR); Hyeong Jin LIM, Seoul (KR)

(21) Appl. No.: 18/013,492

(22) PCT Filed: Nov. 16, 2020
(86) PCT No.: PCT/KR2020/016084

§ 371 Date: Dec. 28, 2022

(30) Foreign Application Priority Data
Sep. 11, 2020 (KR) 10-2020-0116989

(51) Int. Cl. G06N 3/08

(52) U.S. Cl. CPC G06N 3/08

(57) ABSTRACT

Provided is a method and apparatus for automated machine learning, and the method for automated machine learning includes: registering at least one or more first parameter sets including combinations of different set data for at least one or more parameters having an influence on the performance of learning models; choosing at least one or more second parameter sets to be used for the production of the learning models from the first parameter sets, based on learning conditions inputted; performing learning for network functions, based on the chosen second parameter sets and given input datasets to produce the learning models corresponding to the second parameter sets and calculating validation scores for the respective learning models produced; and choosing one of the produced learning models as an application model, based on the validation scores.

### TECHNICAL FIELD

The present disclosure relates to a method and apparatus for automated machine learning.

### BACKGROUND ART

Machine learning is a branch of artificial intelligence, which develops algorithms and technologies capable of giving computers the capability to learn, based on data, so that it has provided excellent performance on prediction, detection, classification, segmentation, anomaly detection, and the like as major techniques in various fields of image processing, image recognition, voice recognition, internet search, etc.

To build a learning model for target performance through the machine learning, neural networks for the machine learning have to be appropriately chosen. However, an absolute standard does not exist in choosing the neural networks, and accordingly, it is very hard to choose the neural networks adequate for the characteristics of the field to be applied or input data.

According to types of datasets, for example, a network with deep layers may have good performance, but even a network with shallow layers may exert performance as required. In the case of industry, in specific, inference time in the machine learning is very important, and therefore, the deep neural networks are not proper.

Further, the performance of the learning model is influenced by a plurality of hyper parameters set by a user, and accordingly, it is important in the machine learning that the hyper parameters are set correspondingly to the characteristics of the input data.

According to the characteristics of black boxes of the machine learning, however, very exhausting experiments for the number of all cases if possible are required to choose the hyper parameters adequate for the input datasets. If the user is not a professional, in this case, it is hard to presume that what types of hyper parameters create significant changes.

### DISCLOSURE OF THE INVENTION

### Technical Problems

Accordingly, it is an object of the present disclosure to provide a method and apparatus for automated machine learning that are capable of rapidly and automatically optimizing network functions and parameters of the network functions and thus allowing them to be adequate for the characteristics of input data.

The technical problems to be achieved through the present disclosure are not limited as mentioned above, and other technical problems not mentioned herein will be obviously understood by one of ordinary skill in the art through the following description.

### Technical Solutions

To accomplish the above-mentioned objects, according to one aspect of the present disclosure, a method for automated machine learning may include the steps of: registering at least one or more first parameter sets including combinations of different set data for at least one or more parameters having an influence on the performance of learning models; choosing at least one or more second parameter sets to be used for the production of the learning models from the first parameter sets, based on learning conditions inputted; performing learning for network functions, based on the chosen second parameter sets and given input datasets to produce the learning models corresponding to the second parameter sets and calculating validation scores for the respective learning models produced; and choosing one of the produced learning models as an application model, based on the validation scores.

According to an exemplary embodiment of the present invention, the step of registering the first parameter sets may include the steps of: combining the different set data for the at least one or more parameters to produce a plurality of candidate parameter sets; performing the learning for network functions with respect to the produced respective candidate parameter sets through a first dataset to perform cross validation for the candidate parameter sets; and determining at least one or more candidate parameter sets as the first parameter sets according to the results of the cross validation.

According to an exemplary embodiment of the present invention, the step of performing the cross validation and the step of determining the at least one or more candidate parameter sets as the first parameter sets may be repeatedly performed, based on a second dataset different from the first dataset.

According to an exemplary embodiment of the present invention, the results of the cross validation may include the average and standard deviation of validation scores calculated for the respective candidate parameter sets, and in the step of determining the at least one or more candidate parameter sets as the first parameter sets, statistical comparison is performed based on the average and standard deviation of the validation scores, and the candidate parameter sets having performance greater than the give baseline are determined as the first parameter sets.

According to an exemplary embodiment of the present invention, the first parameter sets may include the set data for at least one of parameters of types of network functions, an optimizer, a learning rate, and data augmentation.

According to an exemplary embodiment of the present invention, the learning conditions may be related to at least one of learning environment, inference speed, and search range.

According to an exemplary embodiment of the present invention, the step of choosing the second parameter set may include the steps of: sorting the first parameter sets with respect to at least one of architecture and inference speed; and choosing a given top percentage of the first parameter sets sorted according to the learning conditions inputted as the second parameter sets.

According to an exemplary embodiment of the present invention, the validation scores may be calculated based on at least one of recall, precision, accuracy, and a combination thereof.

To accomplish the above-mentioned objects, according to yet still another aspect of the present disclosure, a apparatus for automated machine learning may include: a memory for storing a program for automated machine learning; and a processor for executing the program to register at least one or more first parameter sets including combinations of different set data for at least one or more parameters having an influence on the performance of learning models, choose at least one or more second parameter sets to be used for the production of the learning models from the first parameter sets, based on learning conditions inputted, perform learning for network functions, based on the chosen second parameter sets and given input datasets to produce the learning models corresponding to the second parameter sets and calculating validation scores for the respective learning models produced, and choose one of the produced learning models as an application model, based on the validation scores.

According to an exemplary embodiment of the present invention, the processor may combine the different set data for the at least one or more parameters to produce a plurality of candidate parameter sets, perform the learning for network functions with respect to the produced respective candidate parameter sets through a first dataset to perform cross validation for the candidate parameter set, and determine at least one or more candidate parameter sets as the first parameter sets according to the results of the cross validation.

According to an exemplary embodiment of the present invention, the processor may repeatedly perform the cross validation and the determination of the first parameter sets according to the results of the cross validation, based on a second dataset different from the first dataset.

According to an exemplary embodiment of the present invention, the processor may calculate the average and standard deviation of the validation scores for the respective candidate parameter sets according to the cross validation, perform statistical comparison based on the average and standard deviation of the validation scores, and determine the candidate parameter sets having performance greater than a give baseline as the first parameter sets.

According to an exemplary embodiment of the present invention, the first parameter sets may include the set data for at least one of parameters of types of network functions, an optimizer, a learning rate, and data augmentation.

According to an exemplary embodiment of the present invention, the learning conditions may be related to at least one of learning environment, inference speed, and search range.

According to an exemplary embodiment of the present invention, the processor may sort the first parameter sets with respect to at least one of architecture and inference speed and choose a given top percentage of the first parameter sets sorted according to the learning conditions inputted as the second parameter sets.

According to an exemplary embodiment of the present invention, the validation scores may be calculated based on at least one of recall, precision, accuracy, and a combination thereof.

Advantageous Effectiveness

According to the embodiments of the present disclosure, the method and apparatus for automated machine learning allows the choice of the adequate network functions and the optimization of the hyper parameters to be automatically performed only if the learning conditions and the input data are inputted by the user, so that the learning models can be easily produced and utilized even if the user is not a professional.

According to the embodiments of the present disclosure, further, the method and apparatus for automated machine learning allows the significant hyper parameter combinations having the performance greater than the given baseline to be searched in advance and registered for the preset groups, so that the search range and time required for the optimization of the hyper parameters can be minimized.

The effectiveness of the present disclosure is not limited as mentioned above, and it should be understood to those skilled in the art that the effectiveness of the present disclosure may include another effectiveness as not mentioned above from the detailed description of the present invention.

### BRIEF DESCRIPTION OF DRAWINGS

A brief description of the drawings is given to allow the drawings suggested in the present disclosure to be more clearly understood.

FIG. 1 is a graph showing parameter optimization of a network function.

FIG. 2 is a flowchart showing a method for automated machine learning according to an embodiment of the present disclosure.

FIG. 3 is a flowchart showing an embodiment of a step S210 of FIG. 2.

FIG. 4 is a flowchart showing an embodiment of a step S220 of FIG. 2.

FIG. 5 is an exemplary view showing a process of registering parameter sets in preset groups in the method for automated machine learning according to the embodiment of the present disclosure.

FIG. 6 is an exemplary view showing a user interface for inputting learning conditions in the method for automated machine learning according to the embodiment of the present disclosure.

FIG. 7 is a schematic block diagram showing a configuration of a apparatus for automated machine learning according to an embodiment of the present disclosure.

### MODE FOR INVENTION

The present disclosure may be modified in various ways and may have several exemplary embodiments, and specific exemplary embodiments of the present disclosure are illustrated in the drawings and described in detail in the detailed description. However, this does not limit the present disclosure within specific embodiments and it should be understood that the present disclosure covers all the modifications, equivalents, and replacements within the idea and technical scope of the invention.

If it is determined that the detailed explanation on the well known technology related to the present disclosure makes the scope of the present disclosure not clear, the explanation will be avoided for the brevity of the description. Terms (for example, the first, the second, etc.) may be used just as identification terms for distinguishing one element from the other element.

In the present disclosure, when it is said that one element is described as being “connected” or “coupled” to the other element, one element may be directly connected or coupled to the other element, but it should be understood that another element may be present between the two elements.

The terms “unit”, “-or/er” and “module” described in the present disclosure indicate a unit for processing at least one function or operation, which may be implemented by hardware such as a processor, a micro processor, a micro controller, a central processing unit (CPU), graphics processing unit (GPU), an accelerate processor unit (APU), a digital signal processor (DSP), an application specific integrated circuit (ASIC), a field programmable gate arrays (FPGA), and the like, software, or a combination thereof.

Further, it should be appreciated that the division of the parts in the present disclosure is just made according to principal functions the parts have. That is, two or more parts as will be discussed below may be combined to one part or one part may be divided into two or more parts according to more specified functions. Moreover, the respective parts as will be discussed in the specification can additionally perform some or all of functions performed by other parts as well as their main functions, and of course, also, some of the main functions of the respective parts can be performed only by other parts.

Hereinafter, embodiments of the present disclosure will be described in detail sequentially.

In the specification, a network function may be used with the same meaning as a neural network. In this case, the neural network is composed of interconnected calculation units, which are commonly called nodes, and the nodes are called neurons. Generally, the neural network is made up of a plurality of nodes. The nodes for constituting the neural network are connected to one another by means of one or more links.

Some of nodes constituting the neural network build one layer based on their distances from an initial input node. For example, a collection of nodes with the distances of n from the initial input node builds an n layer.

The neural network as explained in the specification may include deep neural network (DNN) including a plurality of hidden layers as well as input and output layers. The DNN may include a convolutional neural network (CNN), a recurrent neural network (RNN), and the like.

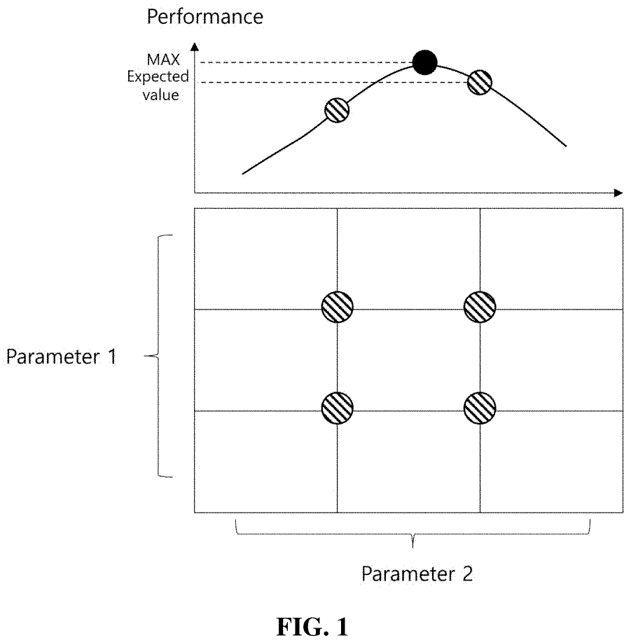

FIG. 1 is a graph showing parameter optimization of a network function.

A network function produces different learning models through learning for different datasets. In this case, the performance (speed, quality, etc.) of the learning models produced from the network function may be influenced by set values of at least one or more parameters. In this case, the parameters are set directly by a user and called variables causing significant changes in the learning models, that is, hyper parameters. For example, the hyper parameters may include variables for types of network functions (or architectures), an optimizer, a learning rate, and data augmentation.

Like this, as the performance of the learning models may vary according to the set values of the parameters, the parameter optimization is first required to thus allow the production and application of the learning models to be adequate for the characteristics of the datasets to be learned.

FIG. 1 conceptually shows a grid search as one method used for the parameter optimization.

The grid search is a process that searches all combinations of set values of the parameters giving significant changes to the performance of learning models within a specific search range. For example, in the process of the grid search, cross validation for network functions is performed through given datasets, based on the differently combined set values of the parameters, to thus check the performance of the learning models, so that the set values of the parameters are optimized.

However, the grid search has to perform the cross validation for the combinations of set values of all parameters, thereby increasing the search range and cost, and accordingly, a method and apparatus for automated machine learning according to the present disclosure that are capable of minimizing both of search space and cost will be explained below.

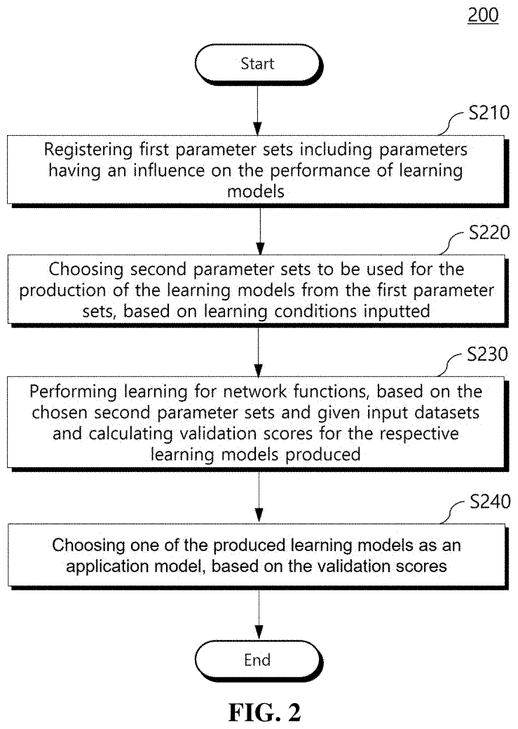

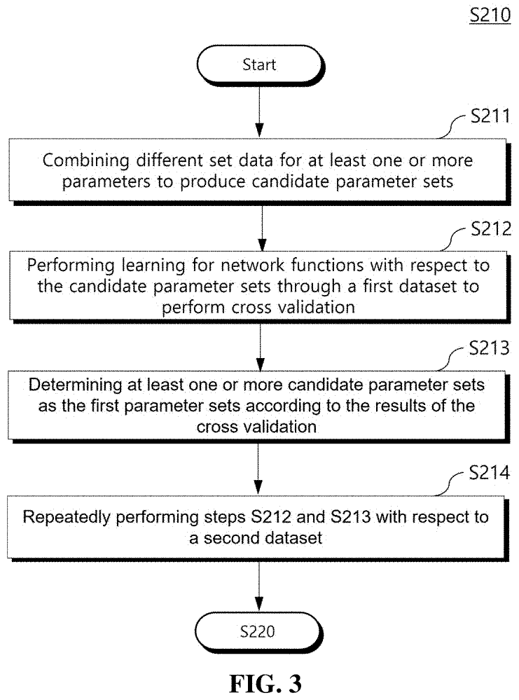

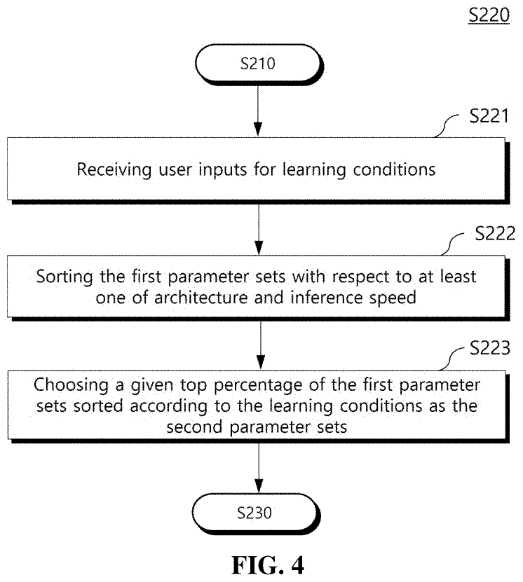

FIG. 2 is a flowchart showing a method for automated machine learning according to the present disclosure, FIG. 3 is a flowchart showing an embodiment of a step S210 of FIG. 2, and FIG. 4 is a flowchart showing an embodiment of a step S220 of FIG. 2.

The method for automated machine learning according to an embodiment of the present disclosure may be performed by a personal computer, a workstation, a computing device for a server, and the like, and otherwise, the method may be performed by a device in which a program for performing the method for automated machine learning is embedded.

Further, the method for automated machine learning according to the embodiment of the present disclosure may be performed by one or more operation devices. For example, at least one or more steps in the method for automated machine learning according to the present disclosure may be performed by a client device, and other steps by a server device. In this case, the client device and the server device are connected to each other by a network and transmit and receive the operation results to and from each other. Otherwise, the method for automated machine learning according to the present disclosure may be performed by distributed computing.

At step S210, first, at least one or more first parameter sets including combinations of different set data for at least one or more parameters having an influence on learning models are registered by a apparatus for automated machine learning.

According to an embodiment of the present disclosure, the parameters represent the hyper parameters as explained in FIG. 1 and are related to at least one of the types of network functions (e.g., types of CNNs, etc.), optimizer, learning rate, and data augmentation. For example, the first parameter sets are made up of combinations of set data for at least one or more hyper parameters enabling the learning models to have performance greater than a given baseline.

According to an embodiment of the present disclosure, the step S210 includes steps S211 to S214, as shown in FIG. 3.

At the step S211, the different set data for the at least one or more parameters are combined to produce candidate parameter sets by the apparatus for automated machine learning. For example, the candidate parameter sets include parameters related to at least one of the types of network functions, optimizer, learning rate, and data augmentation, and the set data for the parameters have different combinations according to the respective candidate parameter sets.

At the step S212, next, learning for network functions is performed with respect to the produced respective candidate parameter sets through a first dataset by the apparatus for automated machine learning, so that cross validation is performed. For example, hyper-parameters are set based on the set data included in the respective candidate parameter sets by the apparatus for automated machine learning, and next, the first dataset is divided into k folds, the learning and cross validation for the network functions are performed to calculate the average and standard deviation of the validation scores for the respective candidate parameter sets.

After that, at the step S213, at least one of the candidate parameter sets is registered in preset groups according to the results of the cross validation by the apparatus for automated machine learning. For example, statistical comparison is performed based on the average and standard deviation of the validation scores calculated at the step S212, and the candidate parameter sets having performance greater than the give baseline are registered in the preset groups.

Next, at the step S214, the steps S212 and S213 are repeatedly performed based on at least one second dataset different from the first dataset by the apparatus for automated machine learning. Accordingly, at least one or more parameter sets are registered in the plurality of preset groups corresponding to the different datasets, respectively.

At step S220, at least one or more second parameter sets to be used for the production of the learning models are chosen from the first parameter sets registered in at least one or more preset groups by the apparatus for automated machine learning.

According to an embodiment of the present disclosure, the step S220 includes steps S221 to S223, as shown in FIG. 4.

At the step S221, user inputs for learning conditions are received by the apparatus for automated machine learning. For example, a given user interface is provided for a user terminal or a display unit included in the apparatus for automated machine learning, and the learning conditions inputted from the user interface are received. According to an embodiment of the present invention, the learning conditions may include at least one of learning environment (PC or embedded device), inference speed, and search range. In this case, the conditions on the search range represent the conditions for determining whether how many first parameter sets registered in the preset groups are used (that is, a rate of the first parameter sets chosen as the second parameter sets).

According to the embodiment of the present disclosure, at the step S221, input datasets are further received from the user terminal to the apparatus for automated machine learning.

Next, at the step S222, the first parameter sets registered in the at least one or more preset groups are sorted with respect to at least one of architecture and inference speed.

For example, the first parameter sets are primarily sorted with respect to the architecture corresponding to the learning environment inputted by the user, and next, the first parameter sets are secondarily sorted based on the recorded inference speeds for the first parameter sets obtained at the step S210 (that is, in order from lowest inference speed to the highest inference speed).

After that, at the step S223, a given top percentage of the first parameter sets sorted at the step S222 according to the learning conditions inputted by the user is chosen as the second parameter sets by the apparatus for automated machine learning.

According to an example of the present disclosure, the given top percentage of the first parameter sets is chosen as the second parameter sets, based on the inference speed level and/or search range level inputted by the user, by the apparatus for automated machine learning. For example, if the inference speed inputted by the user has a level 3, the top 20% of the first parameter sets are chosen as the second parameter sets, and if the inference speed inputted by the user has a level 2, the top 50% of the first parameter sets are as the second parameter sets.

According to an embodiment of the present disclosure, the steps S222 and S223 are performed individually by preset group. If the plurality of preset groups exist, the sorting of the first parameter sets included in the preset groups and the choice of the second parameter sets are performed by preset group.

At step S230, the learning for the network functions is performed, based on the chosen second parameter sets and the input datasets, to produce different learning models, and validation scores for the respective learning models produced are calculated.

For example, the hyper parameters of the network functions are set as set data of the second parameter sets, and at least some of the input datasets are inputted as learning data to the network functions, and the network functions are learned to produce the learning models.

According to an embodiment of the present disclosure, the validation scores are calculated based on at least one of recall, precision, accuracy, and a combination thereof. For example, if the learning models are for object detection and/or classification, the validation scores are calculated based on recall, and if the learning models are for object segmentation, the validation scores are calculated based on F1 score as a combination of recall and precision. However, the present disclosure may not be limited thereto.

At step S240, one of the produced learning models is chosen as an application model, based on the validation scores calculated at the step S230, by the apparatus for automated machine learning.

According to an embodiment of the present disclosure, the learning model having the highest validation score is chosen as the application model by the apparatus for automated machine learning. According to the embodiment of the present disclosure, further, if the number of learning models having the highest validation score is plural, the learning model produced by the second parameter sets sorted with higher percentage is chosen as the application model by the apparatus for automated machine learning.

After that, if the application model is determined, the application model is evaluated through test sets as some of the input datasets, and through the application model, results required by the user are obtained.

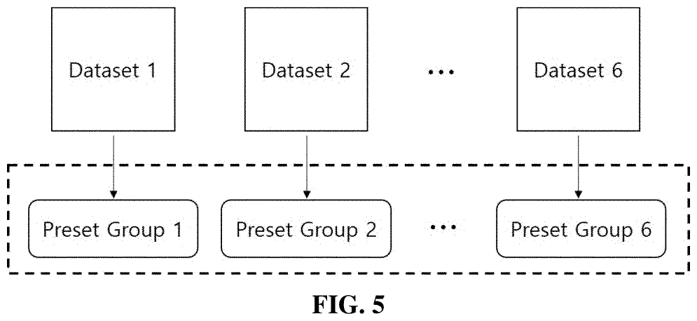

FIG. 5 is an exemplary view showing a process of registering the parameter sets for the preset groups in the method for automated machine learning according to the embodiment of the present disclosure.

As shown in FIG. 5, in the candidate parameter sets including different combinations of set data for at least one or more hyper parameters, the candidate parameter sets having the performance greater than the given baseline are registered in the preset groups by using different six datasets.

In this case, six preset groups corresponding to the six datasets are produced, and the cross validation using the respective datasets is repeatedly performed for the candidate parameter sets, so that the candidate parameter sets are registered in the preset groups corresponding to the datasets.

The information of the parameter sets registered in the preset groups is recorded in the apparatus for automated machine learning or an external server communicating with the apparatus for automated machine learning.

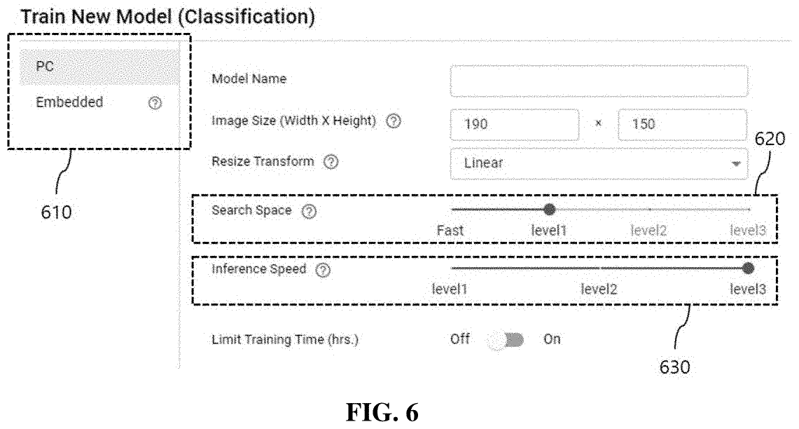

FIG. 6 is an exemplary view showing the user interface for inputting the learning conditions in the method for automated machine learning according to the embodiment of the present disclosure.

The user interface is provided for the user terminal or the display unit included in the apparatus for automated machine learning to receive the user inputs for the learning conditions.

For example, the user interface includes an area 610 for setting learning environments, an area 620 for setting levels of search space, and an area 630 for setting levels of inference speed.

Through the user interface, the user can set whether the parameter sets registered in the preset groups are chosen by any of the learning environments or which percentages of parameter sets registered by level are used.

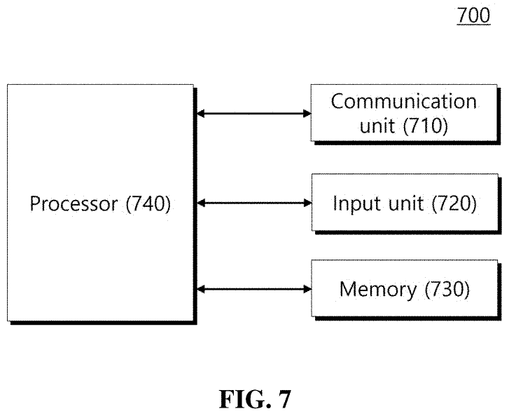

FIG. 7 is a schematic block diagram showing a configuration of the apparatus for automated machine learning according to an embodiment of the present disclosure.

A communication unit 710 transmits and receives data or signals to and from the external device (user terminal, etc.) or external server under the control of a processor 740. The communication unit 710 includes wired and wireless communication units. If the communication unit 710 includes the wired communication unit, it may include one or more components for performing communication through a local area network (LAN), a wide area network (WAN), a value added network (VAN), a mobile radio communication network, a satellite communication network, and a combination thereof. If the communication unit 710 includes the wireless communication unit, further, it may transmit and receive data or signals wirelessly by using cellular communication, a wireless LAN (e.g., Wi-Fi), and the like.

An input unit 720 receives various user commands through external control. To do this, the input unit 720 includes one or more input devices or is connected to the input devices. For example, the input unit 720 is connected to an interface for various inputs, such as a keypad, a mouse, and the like and receives user commands from the interface. To do this, the input unit 720 includes an interface such as a USB port, a Thunderbolt interface, and the like. Further, the input unit 720 includes various input devices such as a touch screen, a button, and the like or is connected to the input devices to receive the user commands from the outside.

A memory 730 stores programs for operating the processor 740 and temporarily or permanently stores data inputted and outputted. The memory 730 includes at least one storage medium of a flash memory, a hard disc, a multimedia card micro storage medium, a card type memory (e.g., SD or XD memory), random access memory (RAM), a static RAM (SRAM), a read-only memory (ROM), an electrically erasable programmable ROM (EEPROM), a programmable ROM (PROM), a magnetic memory, a magnetic disc, and an optical disc.

Further, the memory 730 stores various network functions and algorithms, while storing various data, programs (with one or more instructions), applications, software, commands, and codes for operating and controlling the apparatus 700.

The processor 740 controls all of operations of the apparatus 700. The processor 740 executes one or more programs stored in the memory 730. The processor 740 represents a central processing unit (CPU), a graphics processing unit (GPU), or a dedicated processor through which the method according to the embodiment of the present invention is performed.

According to the embodiment of the present disclosure, the processor 740 serves to register at least one or more first parameter sets including combinations of different set data for at least one or more parameters having an influence on the performance of learning models.

According to the embodiment of the present disclosure, the processor 740 serves to combine the different set data for the at least one or more parameters to produce a plurality of candidate parameter sets, perform learning for network functions with respect to the produced respective candidate parameter sets through a first dataset to perform cross validation for the candidate parameter sets, and determine at least one or more candidate parameter sets as the first parameter sets according to the results of the cross validation.

According to the embodiment of the present disclosure, the processor 740 repeatedly performs the cross validation and the determination of the first parameter sets according to the results of the cross validation, based on a second dataset different from the first dataset.

According to the embodiment of the present disclosure, the processor 740 calculates the average and standard deviation of the validation scores for the respective candidate parameter sets according to the cross validation, performs the statistical comparison based on the average and standard deviation of the validation scores, and determines the candidate parameter sets having performance greater than a give baseline as the first parameter sets.

According to the embodiment of the present disclosure, the processor 740 chooses at least one or more second parameter sets to be used for the production of the learning models from the first parameter sets, based on the learning conditions inputted.

According to the embodiment of the present invention, the processor 740 sorts the first parameter sets with respect to at least one of architecture and inference speed and chooses a given top percentage of the first parameter sets sorted according to the learning conditions inputted as the second parameter sets.

According to the embodiment of the present disclosure, the processor 740 performs learning for network functions, based on the chosen second parameter sets and given input datasets to produce the learning models corresponding to the second parameter sets, calculates validation scores for the respective learning models produced, and chooses one of the produced learning models as an application model, based on the validation scores. In this case, the validation scores are calculated based on at least one of recall, precision, accuracy, and a combination thereof.

Even though not shown in FIG. 7, the apparatus 700 for automated machine learning may further include an output unit, the display unit, and the like.

The output unit generates the outputs relating to sight, hearing, vibration, and the like and includes the display unit, an acoustic output unit, a motor, and the like.

The display unit displays the user interface for inputting the learning conditions and the input datasets, outputs of learning models, and the like.

According to the various embodiments of the present disclosure, as mentioned above, only if the learning conditions and the input data are inputted by the user, the selection of the adequate network functions and the optimization of the hyper parameters are automatically performed, so that the learning models can be easily produced and utilized even if the user is not a professional.

According to the various embodiments of the present disclosure, further, the significant hyper parameter combinations having the performance greater than the given baseline are searched in advance and registered for the preset groups, so that the search range and time required for the optimization of the hyper parameters can be minimized.

The method for automated machine learning according to the embodiment of the present disclosure may be implemented in the form of a program instruction that can be performed through various computers, and may be recorded in a computer readable recording medium. The computer readable medium may include a program command, a data file, a data structure, and the like independently or in combination. The program instruction recorded in the recording medium is specially designed and constructed for the present disclosure, but may be well known to and may be used by those skilled in the art of computer software. The computer readable recording medium may include a magnetic medium such as a hard disc, a floppy disc, and a magnetic tape, an optical recording medium such as a compact disc read only memory (CD-ROM) and a digital versatile disc (DVD), a magneto-optical medium such as a floptical disk, and a hardware device specifically configured to store and execute program instructions, such as a read only memory (ROM), a random access memory (RAM), and a flash memory. Further, the program command may include a machine language code generated by a compiler and a high-level language code executable by a computer through an interpreter and the like.

Further, the method for automated machine learning according to the disclosed embodiments is included in a computer program product. The computer program product as a product may be traded between a seller and a buyer.

The computer program product may include an S/W program and a computer readable storage medium in which the S/W program is stored. For example, the computer program product may include an S/W program type product (e.g., downloadable app) electronically distributed through a manufacturing company of an electronic device or electronic market (e.g., Google play store, an app store, etc.). To do such electronic distribution, at least a portion of the S/W program may be stored in the storage medium or temporarily produced. In this case, the storage medium may be a storage medium of a server of the manufacturing company, a server of the electronic market, or a broadcast server for temporarily storing the S/W program.

The computer program product may include a storage medium of a server or a storage medium of a client device in a system composed of the server and the client device. If a third device (e.g., smartphone) connected to the server or client device exists, the computer program product may include a storage medium of the third device. Otherwise, the computer program product may include an S/W program itself transmitted from the server to the client device or the third device or from the third device to the client device.

In this case, one of the client device and the third device executes the computer program product to perform the method according to the disclosed embodiments of the present invention. Further, two or more devices of the server, the client device and the third device execute the computer program product to distributedly perform the method according to the disclosed embodiments of the present invention.

For example, the server (e.g., a cloud server or artificial intelligence server) executes the computer program product stored therein and controls the client device connected thereto to perform the method according to the embodiments of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method for automated machine learning comprising:
registering at least one or more first parameter sets including combinations of different set data for at least one or more parameters having an influence on performance of learning models;
choosing at least one or more second parameter sets to be used for production of the learning models from the at least one or more first parameter sets, based on learning conditions inputted;
producing learning models corresponding to the at least one or more second parameter sets by performing learning for network functions based on the chosen at least one or more second parameter sets and given input datasets, and calculating validation scores for respective learning models produced; and
choosing one of the produced learning models as an application model, based on the calculated validation scores.

2. The method according to claim 1, wherein the registering the at least one or more first parameter sets comprises:
combining the different set data for the at least one or more parameters to produce a plurality of candidate parameter sets;
performing cross validation for the plurality of candidate parameter sets by performing the learning for the network functions with respect to the produced respective candidate parameter sets through a first dataset; and
determining at least one or more candidate parameter sets as the at least one or more first parameter sets according to results of the cross validation.

3. The method according to claim 2, wherein the performing the cross validation and the determining the at least one or more candidate parameter sets as the at least one or more first parameter sets are repeatedly performed, based on a second dataset which is different from the first dataset.

4. The method according to claim 2, wherein the results of the cross validation comprise an average and standard deviation of validation scores calculated for the respective candidate parameter sets, and
wherein in the determining the at least one or more candidate parameter sets as the first parameter sets, statistical comparison is performed based on the average and standard deviation of the validation scores, and the at least one or more candidate parameter sets having performance greater than a given baseline are determined as the at least one or more first parameter sets.

5. The method according to claim 1, wherein the at least one or more first parameter sets comprise the set data for at least one of parameters of types of network functions, an optimizer, a learning rate, and data augmentation.

6. The method according to claim 1, wherein the learning conditions are related to at least one of learning environment, inference speed, and search range.

7. The method according to claim 6, wherein the choosing the at least one or more second parameter sets comprises:
sorting the at least one or more first parameter sets with respect to at least one of architecture and the inference speed; and
choosing a given top percentage of the at least one or more first parameter sets sorted according to the learning conditions inputted as the at least one or more second parameter sets.

8. The method according to claim 1, wherein the validation scores are calculated based on at least one of recall, precision, accuracy, and a combination thereof.

9. A apparatus for automated machine learning, comprising:
a memory for storing a program for the automated machine learning; and
a processor for executing the program and configured to:
register at least one or more first parameter sets including combinations of different set data for at least one or more parameters having an influence on performance of learning models;
choose at least one or more second parameter sets to be used for production of the learning models from the at least one or more first parameter sets, based on learning conditions inputted;
produce learning models corresponding to the at least one or more second parameter sets by performing learning for network functions, based on the chosen at least one or more second parameter sets and given input datasets, and calculate validation scores for respective learning models produced; and
choose one of the produced learning models as an application model, based on the calculated validation scores.

10. The apparatus according to claim 9, wherein the processor is further configured to:
combine the different set data for the at least one or more parameters to produce a plurality of candidate parameter sets;
performing cross validation for the plurality of candidate parameter sets by performing the learning for the network functions with respect to the produced respective candidate parameter sets through a first dataset; and
determine at least one or more candidate parameter sets as the at least one or more first parameter sets according to results of the cross validation.

11. The apparatus according to claim 10, wherein the processor is further configured to repeatedly performs the cross validation and the determination of the at least one or more candidate parameter sets as the at least one or more first parameter sets, based on a second dataset which is different from the first dataset.

12. The apparatus according to claim 10, wherein the processor is further configured to calculate an average and standard deviation of the validation scores for the respective candidate parameter sets; and
perform statistical comparison based on the average and standard deviation of the validation scores, and determine the at least one or more candidate parameter sets having performance greater than a given baseline as the at least one or more first parameter sets.

13. The apparatus according to claim 9, wherein the at least one or more first parameter sets comprise the set data for at least one of parameters of types of network functions, an optimizer, a learning rate, and data augmentation.

14. The apparatus according to claim 9, wherein the learning conditions are related to at least one of learning environment, inference speed, and search range.

15. The apparatus according to claim 9, wherein the processor is further configured to:
sort the at least one or more first parameter sets with respect to at least one of architecture and inference speed; and
choose a given top percentage of the at least one or more first parameter sets sorted according to the learning conditions inputted as the at least one or more second parameter sets.

16. The apparatus according to claim 9, wherein the validation scores are calculated based on at least one of recall, precision, accuracy, and a combination thereof.

17. A computer program stored in a non-transitory recording medium to execute a method for automated machine learning, the method comprising:
registering at least one or more first parameter sets including combinations of different set data for at least one or more parameters having an influence on performance of learning models;
choosing at least one or more second parameter sets to be used for production of the learning models from the at least one or more first parameter sets, based on learning conditions inputted;
producing learning models corresponding to the at least one or more second parameter sets by performing learning for network functions based on the chosen at least one or more second parameter sets and given input datasets, and calculating validation scores for respective learning models produced; and
choosing one of the produced learning models as an application model, based on the calculated validation scores.
